(19) United States
(12) Patent Application Publication
(10) Pub. No.: US 2025/0139836 A1
(43) Pub. Date: May 1, 2025

(54) IMAGE SHOOTING SYSTEM AND IMAGE GENERATING METHOD

(71) Applicant: HTC Corporation, Taoyuan City (TW)

(72) Inventors: Sheng-Le Wang, Taoyuan City (TW); Ching-Chia Chou, Taoyuan City (TW); Chung-Hsiang Chang, Taoyuan City (TW)

(73) Assignee: HTC Corporation, Taoyuan City (TW)

(21) Appl. No.: 18/496,931

(22) Filed: Oct. 30, 2023

(51) Int. Cl. G06T 11/00; G06F 1/16; G06F 3/01; G06F 3/14; G06T 7/70

(52) U.S. Cl. CPC G06T 11/00; G06F 1/163; G06F 3/011; G06F 3/1423; G06T 7/70; G06T 2207/30196

(57) ABSTRACT

An image shooting system and an image generating method are provided. The image shooting system includes a display device, an image shooting device, and a control device. The display device is configured to display prompt information and virtual interactive object information. The image shooting device is configured to shoot a user image. The control device is configured to: provide the prompt information and the virtual interactive object information to the display device; perform a spatial positioning on a virtual space and a user space to generate spatial positioning information; and combine a virtual image and the user image to generate an output image according to the spatial positioning information.

### BACKGROUND

### Technical Field

The disclosure relates to an image shooting system and an image generating method, and in particular, to an image shooting system and an image generating method that may combine a virtual image and an actual image.

### Description of Related Art

With the advancement of electronic technology, many different display devices have been proposed. Among them, head-mounted displays capable of providing virtual reality and augmented reality effects have become products that have attracted public attention in recent years. As the technology of head-mounted displays becomes increasingly mature, head-mounted displays have begun to be used in many areas of people's lives.

### SUMMARY

The disclosure provides an image shooting system and an image generating method, which may combine a virtual image and an actual image.

An image shooting system of the disclosure includes a first display device, an image shooting device, and a control device. The first display device is configured to display prompt information and virtual interactive object information. The image shooting device is configured to shoot a user image. The control device is coupled to the first display device and the image shooting device. The control device is configured to: provide the prompt information and the virtual interactive object information to the display device; perform a spatial positioning on a virtual space and a user space of a user to generate spatial positioning information; and combine a virtual image and the user image to generate an output image according to the spatial positioning information.

An image generating method of the disclosure includes the following steps. A first display device is provided to display prompt information and virtual interactive object information. An image shooting device is provided to shoot a user image. A control device is provided to: provide the prompt information and the virtual interactive object information to the display device; perform a spatial positioning on a virtual space and a user space of a user to generate spatial positioning information; and combine a virtual image and the user image to generate an output image according to the spatial positioning information.

Based on the above, the image shooting system of the disclosure displays the prompt information and the virtual interactive object information through the display device. Actors may perform corresponding actions based on the prompt information and the interactive object information. On the other hand, the image shooting device may be configured to shoot the user image to obtain a physical image. The image shooting system of the disclosure further synthesizes the virtual image and the user image which is a physical image to generate the output image.

### BRIEF DESCRIPTION OF THE DRAWINGS

FIG. 1 is a schematic diagram of an image shooting system according to an embodiment of the disclosure.

FIG. 2 is an image shooting system according to an embodiment of the disclosure.

FIG. 3 is a schematic diagram of a shooting operation of a user image of an image shooting system according to an embodiment of the disclosure.

FIG. 4 is a schematic diagram of a control device in an image shooting system according to an embodiment of the disclosure.

FIG. 5 is a schematic diagram of a virtual image and a user image in an image shooting system according to an embodiment of the disclosure.

FIG. 6 is a schematic diagram of an image shooting system according to another embodiment of the disclosure.

FIG. 7 is a schematic diagram of display screens of display devices of a monitoring-end device and a designer-end device according to an embodiment of the disclosure.

FIG. 8A to FIG. 8C are schematic diagrams of an image shooting process of an image shooting system according to an embodiment of the disclosure.

FIG. 9 is a flowchart of an image generating method according to an embodiment of the disclosure.

### DESCRIPTION OF THE EMBODIMENTS

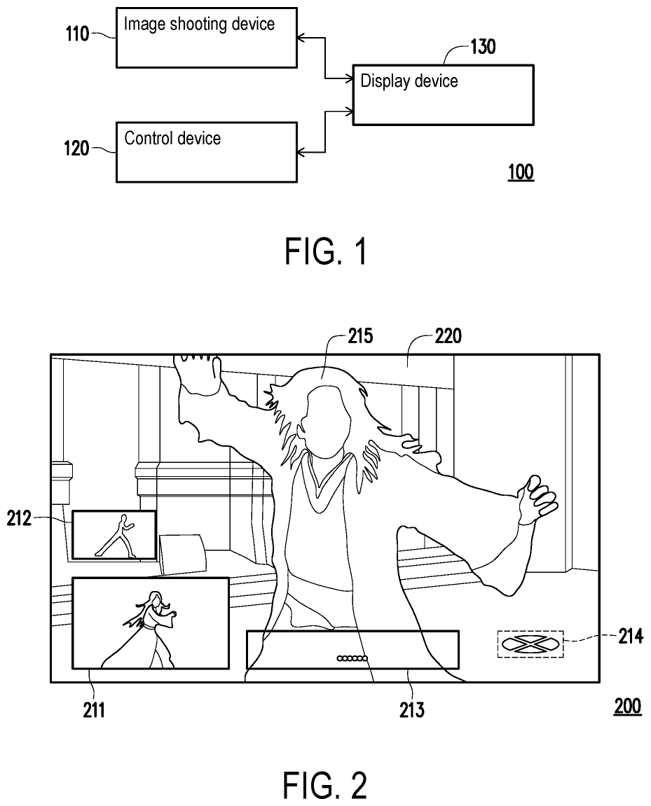

Please refer to FIG. 1. FIG. 1 is a schematic diagram of an image shooting system according to an embodiment of the disclosure. An image shooting system 100 includes an image shooting device 110, a control device 120, and a display device 130. The display device 130 is coupled to the image shooting device 110 and the control device 120. The display device 130 may be a head-mounted display device, and the display device 130 may be worn on a user (e.g., the person being photographed, that is, the performer) when an image shooting operation is performed.

The display device 130 may be configured to display prompt information and virtual interactive object information, and provide relevant information about the performer's performance actions. Reference may be made simultaneously to FIG. 1 and FIG. 2. FIG. 2 is a schematic diagram of prompt information and virtual interactive object information provided by the display device 130 in an image shooting system according to an embodiment of the disclosure. In FIG. 2, a display image 200 provided by the display device 130 may include prompt information 211, 212, 213, and 214 and virtual interactive object information 215. The prompt information 212 may be body movement information of the performer; the prompt information 211 may be body status information of the current performer; the prompt information 213 may be prompt information of the performer's lines; and the prompt information 214 may be movement prompt information of the performer. The interactive object information 215 provides virtual information of the performer's opponent character and performance occasion. In addition to virtual image information, the display device 130 may also synchronously send sound effects corresponding to the opponent character and performance occasion, and the sound effects may also be part of the interactive object information 215.

In the embodiment of the disclosure, the display device 130 may display one or more of the prompt information 211, 212, 213, and 214.

The prompt information 212 may represent actions that the performer is expected to perform next. The prompt information 213 may be text information, and may display information about the lines that the current performer wants to speak. The prompt information 214 may have a plurality of orientation indicators to prompt the performer with information about the direction in which the performer currently wants to move. The prompt information 212, 213, and 214 may all be set in advance and may all be time stream information. The display device 130 may also display prompt information 212, 213, and and 214 according to a timeline of image shooting.

Here, display positions of the prompt information 211 to 214 may be adjusted by the user. The illustration in FIG. 2 is only an example for illustration and is not intended to limit the scope of the disclosure.

The interactive object information 215 may be preset shooting image information, and is provided as a virtual interactive object for the performer when the performer performs the performance. The interactive object information 215 may have only a background image, only an opponent character, or both a background image and one or more opponent characters.

The image shooting device 110 is configured to shoot an actual performance image of the performer and obtain a user image. In the embodiment, the performer may perform the performance through the prompt information 211 to 214 and the virtual interactive object information 215 provided by the display device 130, and the image shooting device 110 may simultaneously shoot the image of the performer to generate the user image. In the embodiment, the image shooting device 110 may be a camera.

It is worth mentioning that the prompt information 211 may be generated synchronously based on the user image obtained by the image shooting device 110.

Please refer to FIG. 1 again. The control device 120 is configured to control the image shooting operation of the image shooting system 100. In detail, the control device 120 is configured to: provide the prompt information and the virtual interactive object information 215 to the display device 130; perform a spatial positioning on a virtual space and a user space of the user (performer) to generate spatial positioning information; and combine a virtual image and the user image to generate an output image according to the spatial positioning information. The virtual interactive object information 215 provided by the display device 130 may be located in the virtual space. The space where the performer is located may be the user space. The control device 120 may establish spatial coordinate conversion information between the virtual space and the user space, thereby generating the spatial positioning information.

In addition, the control device 120 also has the virtual image. The virtual image may be in the same virtual space as the interactive object information. The control device 120 may also receive the user image obtained by the image shooting device 110 and combine the virtual image and the user image to generate the output image.

It is worth mentioning that the generating method of the spatial positioning information may be accomplished by applying a spatial coordinate conversion algorithm that is well known to those skilled in the art. An image combination operation of the virtual image and the user image may also be accomplished using an image rendering method that is well known to those skilled in the art, and there is no certain limitation.

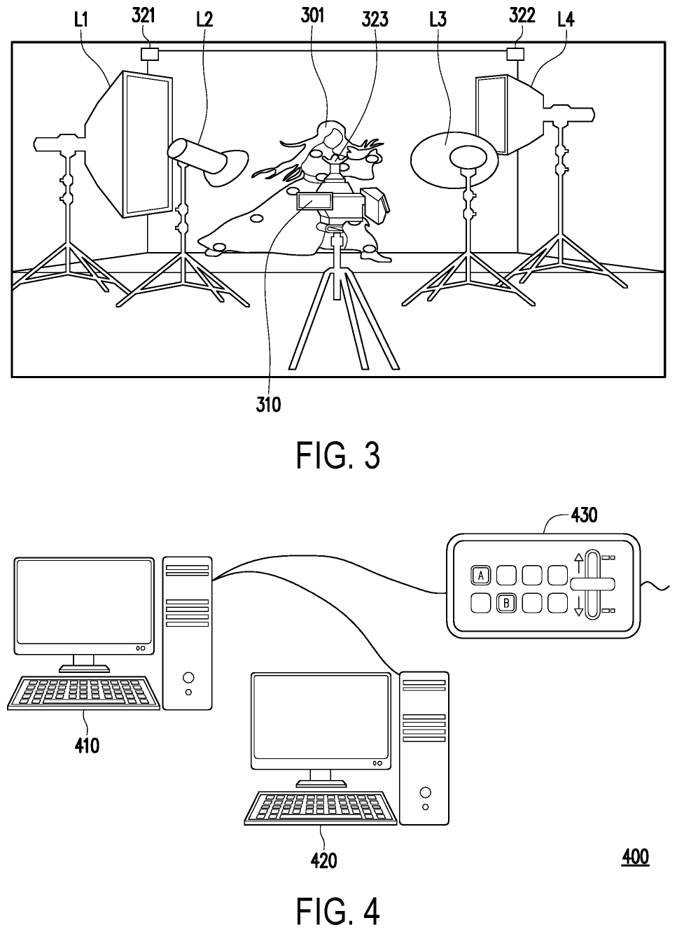

Please refer to FIG. 3. FIG. 3 is a schematic diagram of a shooting operation of a user image of an image shooting system according to an embodiment of the disclosure. The shooting operation of the user image may be carried out in a studio. An image shooting device 310 and corresponding lighting equipment L1 to L4 may be disposed in the studio. In the embodiment, the image shooting device 310 may shoot the performance of a performer 301, thereby obtaining the user image.

It is worth noting that in the user space in the studio, a positioning device with a plurality of locators 321, 322, and 323 may be disposed. The locators 321, 322, and 323 may be disposed on a plurality of different positions in the user space and configured to locate the user space. The locators 321, 322, and 323 may also be a plurality of cameras, and provide the control device with a plurality of image information at different angles, so that the control device may perform a calculation operation on positioning information

Please refer to FIG. 4 below. FIG. 4 is a schematic diagram of a control device in an image shooting system according to an embodiment of the disclosure. A control device 400 includes hosts 410 and 420 and a central controller 430. The host 410 may provide a database. The host 410 may be coupled to the display device worn by the performer, and store and provide the prompt information and the interactive object information to the display device worn by the performer. The host 420 is coupled to the host 410. The host 420 receives the virtual image and the user image obtained by the image shooting device, and combines the virtual image and the user image through an image rendering operation to generate the output image.

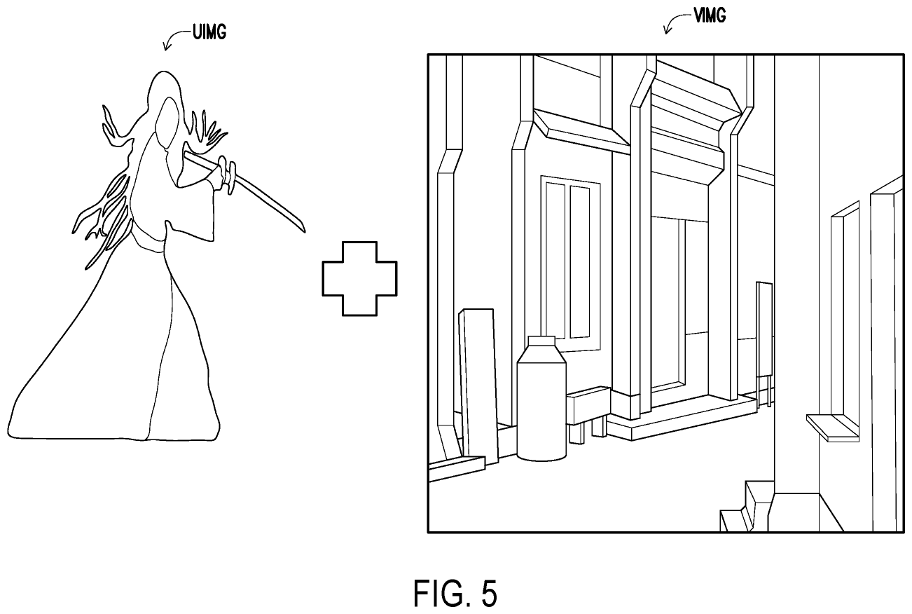

Please refer to a schematic diagram of a virtual image and a user image in an image shooting system according to an embodiment of the disclosure as shown in FIG. 5 below. The host 410 may provide a virtual image VIMG to the host 420. The host 420 may also obtain a user image UIMG from the image shooting device. The host 420 may combine the user image UIMG and the virtual image VIMG to generate the output image.

It is worth mentioning that, referring to FIG. 4 again, the virtual image may be obtained through a virtual image camera. The virtual image camera may be disposed in the host 410 and configured to perform a shooting operation of the virtual image. The virtual image may be obtained before or after the shooting operation of the user image is completed, and there is no certain limitation. The information of the completed virtual image may be stored in the host 410 in advance. When the host 420 wants to execute the virtual image and the user image to perform the image rendering operation, the host 420 may read the relevant information of the virtual image from the host 410.

Incidentally, after performing the shooting operation of the virtual image, the host 410 may perform a special effect adjustment operation on the virtual image to generate an adjusted virtual image. The special effects include any one or more audio and video special effects that may be added to a film, and there is no certain limitation. When the host 420 performs the image rendering operation, the adjusted virtual image may be read by the host 410, so that the adjusted virtual image and the user image may perform image rendering and generate the output image with special effects.

In addition, when the host 420 performs the image rendering operation, one or more virtual objects may be combined with the virtual image and the user image to generate the output image. The virtual object may be, for example, a performer's handheld object or a required shielding object in the image.

The central controller 430 may be a broadcasting machine. The central controller 430 is coupled among the hosts 410 and 420 and the image shooting device. The central controller 430 is configured to control operations of each of the hosts 410 and 420 and the image shooting device.

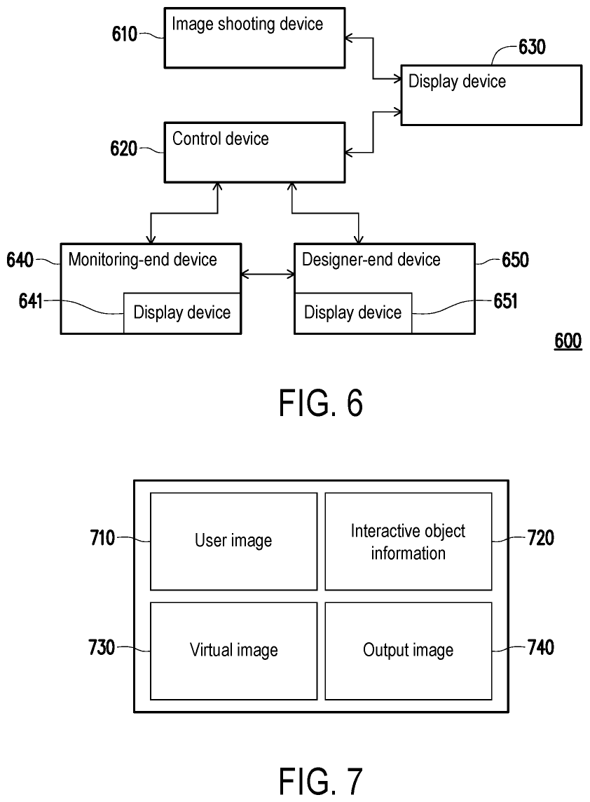

Please refer to FIG. 6. FIG. 6 is a schematic diagram of an image shooting system according to another embodiment of the disclosure. An image shooting system 600 includes an image shooting device 610, a control device 620, a display device 630, a monitoring-end device 640, and a designer-end device 650. The relevant operation details of the image shooting device 610, the control device 620, and the display device 630 have been described in detail in the foregoing embodiments, and thus are not repeated here.

On the other hand, unlike the previous embodiment, the control device 620 is further coupled to the monitoring-end device 640 and the designer-end device 650. The monitoring-end device 640 and the designer-end device 650 have display devices 641 and 651, respectively. The display devices 641 and 651 and the display device 630 may be head-mounted display devices. The display device 641 is configured to be worn on the body of the supervisor (such as the director), and the display device 651 is configured to be worn on the body of the designer.

Please refer to FIG. 6 and FIG. 7 at the same time here. FIG. 7 is a schematic diagram of display screens of display devices of a monitoring-end device and a designer-end device according to an embodiment of the disclosure. Each of the display devices 641 and 651 may be configured to display a user image 710, an interactive object information 720, a virtual image 730, and an output image 740. Through the display image provided by the display device 641, the director of the film may monitor defects generated during the film shooting process and provide adjustment information in real time. It is worth mentioning that in the embodiment, the monitoring-end device 640 and the designer-end device 650 may be coupled to each other, and the adjustment information provided by the director may be transmitted to the designer-end device 650. The designer may also adjust the relevant information based on the adjustment information provided by the director.

It is worth mentioning that the monitoring-end device 640 and the designer-end device 650 may be coupled to each other through a remote connection, and may be coupled to the control device 620 through the remote connection.

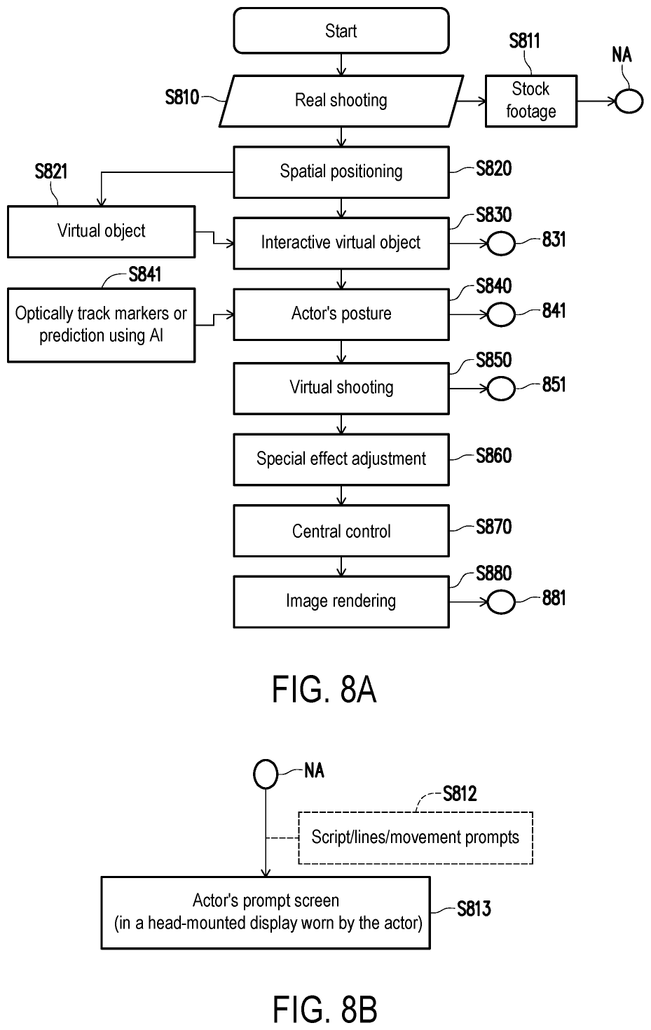

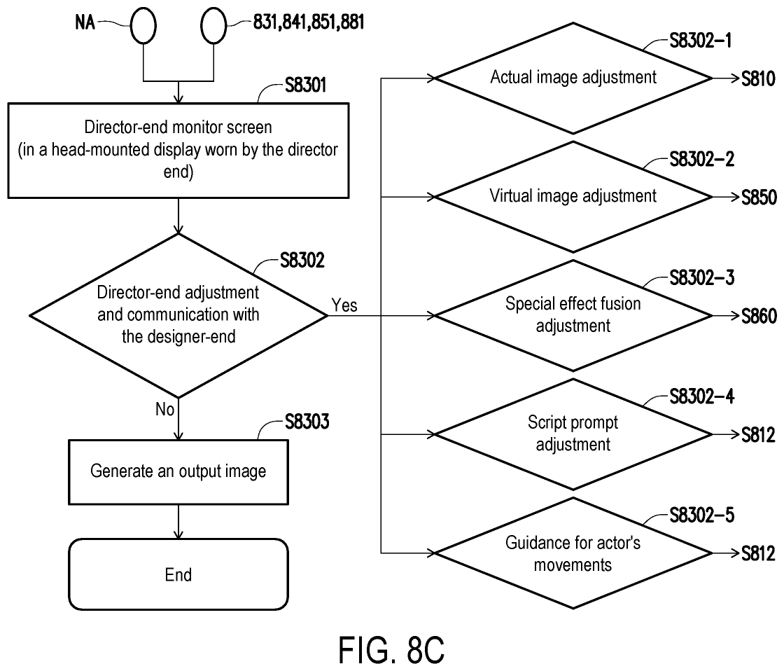

Please refer to FIG. 8A to FIG. 8C below. FIG. 8A to FIG. 8C are schematic diagrams of an image shooting process of an image shooting system according to an embodiment of the disclosure. In FIG. 8A, first in step S810, a real shooting operation may be performed on a user (actor) to obtain a stock footage 811 and enter a node NA. In step S820, a spatial positioning operation may be performed on a user space and a virtual space of a virtual image. In step S821, the virtual objects required in the film may be set, and in step S830, one or more interactive virtual objects may be created, and relevant information 831 of the interactive virtual objects may be generated.

Next, in step S840, an actor's posture may be detected to obtain relevant information 841 of the actor's posture. Step S840 may be performed via step S841 to detect the actor's posture through an optical tracker or through prediction using an artificial intelligence (AI) algorithm.

In step S850, a shooting operation of the virtual image may be performed, thereby obtaining relevant information 851 of the virtual image. In step 860, a special effect adjustment operation may be performed on the virtual image, and central control (step S870) is performed through the central controller to perform an image rendering operation (step S880). Relevant information 881 of an output image may be obtained through step S880.

In FIG. 8B, the node NA is adopted, and according to information 831, 841, 851, and 881, in step S812, relevant information of the script, lines, and movement prompts may be provided, and step S813 may be performed to generate relevant information of an actor's prompt screen. In step S813, relevant information of the actor's prompt screen may be generated through a head-mounted display worn on the actor's head. Based on the prompt screen generated in step S813, the real shooting operation in step S810 of FIG. 8A may be assisted.

In FIG. 8C, the node NA is adopted, and according to the information 831, 841, 851, and 881, in a monitoring-end device, the director may display a monitor screen (including the user image, the interactive object information, the virtual image, and the output image) based on the head-mounted display worn to generate an adjustment information (step S8301). In step S8302, the director end may communicate with the designer end according to the content to be adjusted. If the result of the communication is that no adjustment is required, step S8303 may be performed to generate the output image. On the other hand, if the result of the communication is that adjustment is required, at least one of steps S8302-1 to S8302-5 may be performed. Step S8302-1 performs an adjustment operation of the actual user image; step S8302-2 performs an adjustment operation of the virtual image; step S8302-3 performs an adjustment operation of the special effect fusion; step S8302-4 performs an adjustment operation of the script prompt; and step S8302-5 may provide guidance information for the actor's movements.

It is worth noting that after step S8302-1, step S810 of FIG. 8A may be performed to adjust the user image; after step S8302-2, step S850 of FIG. 8A may be performed to adjust the virtual image; after step S8302-3, step S860 of FIG. 8A may be performed to perform the special effect adjustment; and after steps S8302-4 and S8302-5, step S812 of FIG. 8B may be performed to adjust the provided script, lines, and movement prompts.

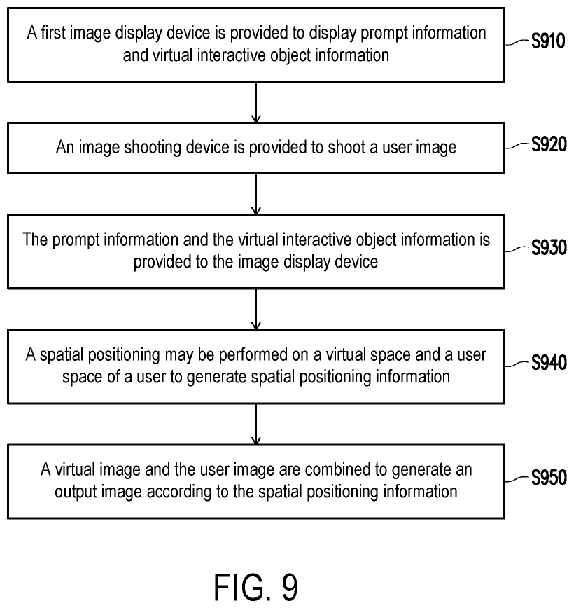

Please refer to FIG. 9 below. FIG. 9 is a flowchart of an image generating method according to an embodiment of the disclosure. In step S910, the first display device is provided to display prompt information and virtual interactive object information. In step S920, the image shooting device is provided to shoot a user image. In step S930, the control device is provided to provide the prompt information and the virtual interactive object information to the display device. In step S940, a spatial positioning may be performed on a virtual space and a user space of a user through the control device to generate spatial positioning information. In step S950, the virtual image and the user image are combined through the control device to generate an output image according to the spatial positioning information.

The implementation details of the plurality of steps S910 to S950 above have been described in detail in the foregoing embodiments, and thus are not repeated here.

To sum up, the image shooting system of the disclosure provides a display device, and enables the performers to perform the performance through the prompt information and the virtual interactive object information displayed on the display device. Furthermore, the image shooting system of the disclosure may generate the output image by synthesizing the virtual image and the user image which is a physical image.

What is claimed is:

1. An image shooting system, comprising:
a first display device, configured to display prompt information and virtual interactive object information;
an image shooting device, configured to shoot a user image; and
a control device, coupled to the first display device and the image shooting device, wherein the control device is configured to:
provide the prompt information and the virtual interactive object information to the first display device;
perform a spatial positioning on a virtual space and a user space of a user to generate spatial positioning information; and
combine a virtual image and the user image to generate an output image according to the spatial positioning information.

2. The image shooting system according to claim 1, wherein the prompt information comprises at least one of body movement information of the user, lines of the user, and movement prompt information of the user.

3. The image shooting system according to claim 1, wherein the control device comprises:
a first host, coupled to the first display device, wherein the first host is configured to store the prompt information and the interactive object information, and provides the prompt information and the interactive object information to the first display device.

4. The image shooting system according to claim 3, wherein the control device further comprises:
a second host, coupled to the first host, and configured to combine the virtual image and the user image to generate the output image through an image rendering operation; and
a central controller, coupled among the first host, the second host, and the image shooting device, and configured to control operations of each of the first host, the second host, and the image shooting device.

5. The image shooting system according to claim 4, wherein the second host further combines at least one virtual object, the virtual image, and the user image to generate the output image.

6. The image shooting system according to claim 4, further comprising:
a monitoring-end device, coupled to the control device, wherein the monitoring-end device has a second display device configured to display the user image, the interactive object information, the virtual image, and the output image.

7. The image shooting system according to claim 4, wherein a monitoring-end device is coupled to the control device through a remote connection.

8. The image shooting system according to claim 4, further comprising:
a designer-end device, coupled to the control device and a monitoring-end device, wherein the designer-end device has a third display device configured to display the user image, the interactive object information, the virtual image, and the output image.

9. The image shooting system according to claim 8, wherein the designer-end device is coupled to the monitoring-end device through a remote connection.

10. The image shooting system according to claim 8, wherein the first display device, a second display device, and the third display device are head-mounted display devices.

11. The image shooting system according to claim 4, wherein the first host comprises a virtual image camera for obtaining the virtual image.

12. The image shooting system according to claim 11, wherein the first host further performs a special effect adjustment operation on the virtual image to generate an adjusted virtual image.

13. The image shooting system according to claim 1, further comprising:
a positioning device, configured to locate the user space of the user.

14. The image shooting system according to claim 13, wherein the positioning device has a plurality of locators, and the locators are disposed in a plurality of different positions of the user space.

15. An image generating method, comprising:
providing a first display device to display prompt information and virtual interactive object information;
providing an image shooting device to shoot a user image; and
providing a control device configured to:
provide the prompt information and the virtual interactive object information to the first display device;
perform a spatial positioning on a virtual space and a user space of a user to generate spatial positioning information; and
combine a virtual image and the user image to generate an output image according to the spatial positioning information.

16. The image generating method according to claim 15, further comprising:
combining at least one virtual object, the virtual image, and the user image to generate the output image.

17. The image generating method according to claim 15, further comprising:
providing a monitoring-end device so that a second display device of the monitoring-end device displays the user image, the interactive object information, the virtual image, and the output image.

18. The image generating method according to claim 17, further comprising:
providing a designer-end device so that a third display device of the designer-end device displays the user image, the interactive object information, the virtual image, and the output image.

19. The image generating method according to claim 15, further comprising:
performing a special effect adjustment operation on the virtual image to generate an adjusted virtual image.

20. The image generating method according to claim 15, further comprising:
respectively disposing a plurality of locators in a plurality of different positions of the user space to locate the user space of the user.
